(19) United States
(12) Patent Application Publication
(10) Pub. No.: US 2010/0240395 A1
(43) Pub. Date: Sep. 23, 2010

(54) POSITIONING METHOD OF A WIRELESS COMMUNICATION DEVICE

(76) Inventor: Li-Qun XU, Nanjing (CN)

Correspondence Address: Muncy, Geissler, Olds & Lowe, PLLC, 4000 Legato Road, Suite 310, FAIRFAX, VA, 22033, US

(21) Appl. No.: 12/721,021

(22) Filed: Mar. 10, 2010

(30) Foreign Application Priority Data
Mar. 19, 2009 (TW) 098108877

(51) Int. Cl. H04W 24/00

(52) U.S. Cl. 455/456.1

(57) ABSTRACT

A positioning method of a wireless communication device includes the steps of: receiving first and second wireless signals from the first and second base stations of first and second networks time of transmitting the first and second wireless signals from the first and second base stations to the wireless communication device respectively; determining first and second domains capable of receiving the first and second wireless signals; obtaining a coordinate of one intersection point of the first and second domains; and integrating the coordinate of the intersection point and a geographical data base to obtain a geographical position of the wireless communication device.

This application claims the benefit of Taiwan Patent Application Serial No.098108877, filed Mar. 19, 2009, the subject matter of which is incorporated herein by reference.

### BACKGROUND OF THE INVENTION

(1) Field of the Invention

The invention relates to a positioning method of a wireless communication device, and more particularly to the positioning method that applies various signals received from different sources to derive the position of the wireless communication device.

(2) Description of the Prior Art

With prospect of the international business and touring, an accurate and convenient positioning method or system, other than the satellite-based global position system (GPS), to help people knowing where they are is definitely welcome in many manifolds. For example, a merchandise-distribution truck may need a position method or apparatus to guide toward the destination.

In the art, the positioning can be made by the GPS or an interpolating computation by evaluating the receiver position among three, at least, transmission stations in a wireless communication system. In the GPS, a satellite/signal receiving device is installed in a vehicle or a mobile apparatus to receive the satellite GPS signals for deriving the instant position. In the wireless communication, a mobile communication device may locate itself by a relevant interpolating computation from its distances to three surrounding transmission base stations under the same service provider.

Nevertheless, accuracy of any of the aforesaid two positioning methods may be limited to the local geographical conditions and the coverage of the particular service provider as well. In the case that the subscriber of the wireless communication service is out of the coverage, then the position function fails due to lack of provider's signals. Ironically, it is always the place that the subscriber needs most his/her mobile device to tell him/her the exact position.

Therefore, it is definite a need to equip the mobile device with a positioning method that can still work even the provider's signals is dumb.

### SUMMARY OF THE INVENTION

Accordingly, it is an object of the present invention to provide a positioning method of a wireless communication device that can utilize signals from different providers to compute the position of the wireless communication device. Thereby, the positioning limited by the coverage of a specific provider, the geographical conditions, and so on can be reduced to a minimum.

The positioning method of a wireless communication device in accordance with the present invention comprises the following steps.

Step 1: The wireless communication device receives a first wireless signal from a first base station and a second wireless signal from a second base station. The first base station and the second base station may belong to different providers.

Step 2: The wireless communication device computes time of transmitting the first and second wireless signals from the first and second base stations to the wireless communication device.

Step 3: According to the computed time, the wireless communication device determines a first domain, which is capable of receiving the first wireless signal and a second domain, which is capable of receiving the second wireless signal.

Step 4: The wireless communication device computes and obtains a coordinate of an intersection point of the first and second domains.

Step 5: Integrating the coordinate of the intersection point and a geographical data base to obtain a geographical position for the wireless communication device.

In the present invention, for the aforesaid wireless signals may originate from different provider's base stations, the wireless communication device can still tell its instant position even in an area where a specific provider cannot reach.

All these objects are achieved by the positioning method of a wireless communication device described below.

### BRIEF DESCRIPTION OF THE DRAWINGS

The present invention will now be specified with reference to its preferred embodiment illustrated in the drawings, in which:

FIG. 1 is a flowchart of a preferred positioning method of a wireless communication device in accordance with the present invention;

FIG. 2 demonstrates an application situation of the preferred positioning method in accordance with the present invention;

FIG. 3 demonstrates another application situation of the preferred positioning method in accordance with the present invention;

FIG. 4 is a flowchart of the wireless communication device to include a third wireless signal, in accordance with the present invention; and

FIG. 5 demonstrates an application situation of another embodiment of the positioning method in accordance with the present invention.

### DESCRIPTION OF THE PREFERRED EMBODIMENT

The invention disclosed herein is directed to a positioning method of a wireless communication device. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

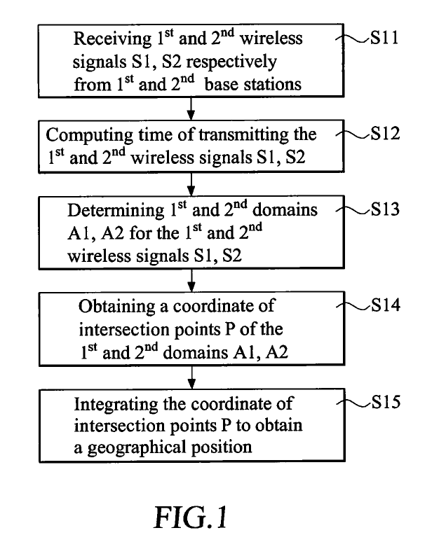

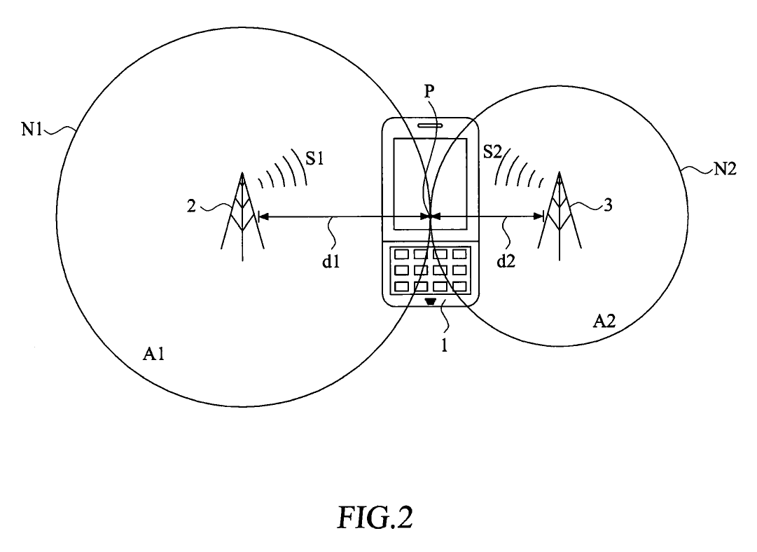

Referring now to FIG. 1 and FIG. 2, a flowchart and an application situation of a preferred positioning method of a wireless communication device in accordance with the present invention are shown, respectively.

Firstly, in Step S11 of FIG. 1, the wireless communication device 1 receives a first wireless signal S1 from a first base station 2 of a first network N1 and a second wireless signal S2 from a second base station 3 of a second network N2. In the present invention, the first network N1 and the second network N2 may belong to different providers.

Then, in Step S12, the wireless communication device 1 computes, by applying an appropriate built-in or far-end software, a first time of transmitting the first wireless signal S1 from the first base station 2 to the wireless communication device 1, and a second time of transmitting the second wireless signal S2 from the second base station 3 to the wireless communication device 1.

In the following Step S13, based on the first time and the second time, the wireless communication device 1 computes and determines a first domain A1, which is capable of receiving the first wireless signal S1 and a second domain A2, which is capable of receiving the second wireless signal S2.

In Step S14, in the case that the first and second domains A1 and A2 intersect only at one point (say, point P as shown), the wireless communication device 1 computes the coordinate of the intersection point P.

Finally, in Step S15, by integrating the coordinate of the intersection point P and a geographical data base available anywhere in the cloud or in the device itself, a geographical position (an accurate position) of the wireless communication device 1 can be derived.

Particularly, in the foregoing Step S13, the first domain A1 obtained from realizing the first time of transmitting the first wireless signal 51 is a circle centered at the first base station 2 and having a radius d1, and the second domain A2 obtained from realizing the second time of transmitting the second wireless signal S2 is another circle centered at the second base station 3 and having a radius d2.

As shown in FIG. 2, in this particular situation, for the wireless communication device 1 locates right on the straight line connecting the first and second base stations 2 and 3, so the circles A1 and A2 can intersect only at a single point P.

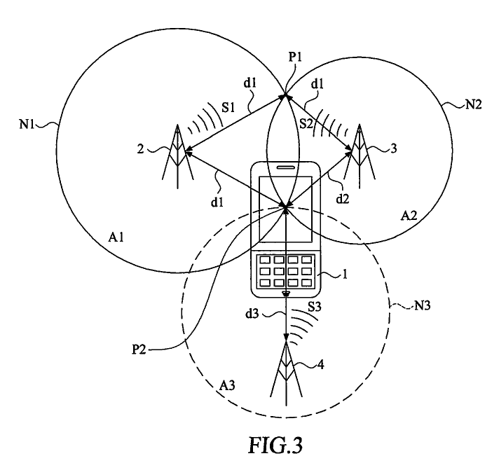

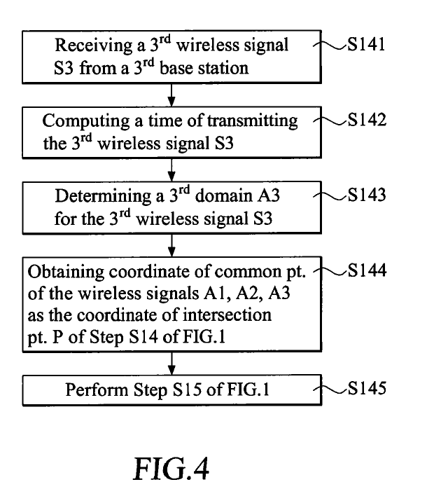

Referring now to FIG. 3, another application situation of the positioning method in accordance with the present invention is demonstrated. As shown, the wireless communication device 1 is not located on, but biased away from, the line connecting the first base station 2 and the second base station 3. Under this circumstance, the first domain A1 and the second domain A2 intersect at two points, P1 and P2; in which either P1 or P2 is the candidate to be the point that exists the wireless communication device 1. However, to ascertain whether P1 or P2 is the point to stand the wireless communication device 1, a help from a third base station 4 is needed. To make sure the position of the wireless communication device 1, following subroutine to be executed between Steps S14 and S15 of FIG. 1 is shown in FIG. 4.

Referring also to FIG. 4, after Step S14 of FIG. 1 is performed, the wireless communication device 1 receives a third wireless signal S3 from a third base station 4 of a third network N3. (Step S141)

Then, the wireless communication device 1 computes a third time of transmitting the third wireless signal S3 from the third base station 4 to the wireless communication device 1. (Step S142)

Based on the third time, the wireless communication device 1 is then to compute a third domain A3 of the third wireless signal S3. (Step S143)

Theoretically, the third domain A3 would cross both the first and second domains A1 and A2 at a common point, either P1 or P2; in which the common point is the position where the wireless communication device 1 stands. In this illustration, P2 is the point to exist the wireless communication device 1. In computation, if one of the intersection points between A3 and A1 (or A2) is found to be P1, then the wireless communication device 1 computes the coordinate of the intersection point P1 to be the coordinate of the intersection point P of Step S14. Otherwise that P2 is the intersection point between A3 and A1 (or A2) to be the common intersection point among A1, A2 and A3, then the wireless communication device 1 computes the coordinate of P2 to be the coordinate of the intersection point P of Step S14. (Step S144)

Finally, perform Step S15 of FIG. 1. (Step S145)

In the present invention, the third domain A3 obtained from realizing the third time of transmitting the third wireless signal S3 is a circle centered at the third base station 4 and having a radius d3.

In the present invention, networks N1, N2 and N3 can be different networks constructed by individual providers (or formats), or can be networks from the same provider. For example, the aforesaid first network N1 can be a network from a global system for mobile communications (GSM), while the aforesaid N2 and N3 can be networks from a system of code division multiple access (CDMA).

In the present invention, the geographical data base mentioned in Step S15 of FIG. 1 is preferred to be a software application installed to the wireless communication device 1. This geographical data base can include information of roads, streets, buildings, specific landmarks, particular geographic points and so on. After the coordinate of P is integrated with the information in the data base, the exact position of the wireless communication device 1 can be better told.

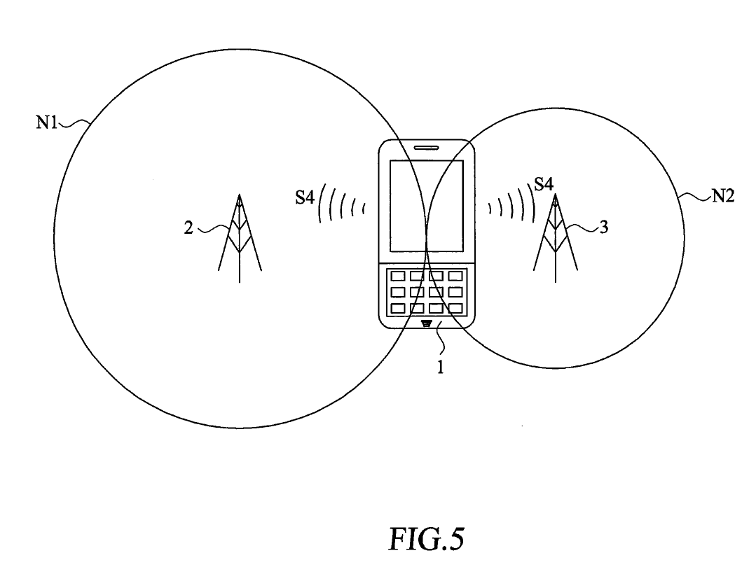

Referring now to FIG. 5, an application situation of another embodiment of the positioning method in accordance with the present invention is illustrated. The major difference between the method of FIG. 1 and the method of FIG. 5 is at the Step S11 of FIG. 1. In the first embodiment, the wireless communication signals S1 and S2 are transmitted by individual base stations 2 and 3, respectively. However, in this embodiment, the wireless communication device 1 is responsible to transmit the position-inquiry signals S4 to the neighboring base stations.

As shown, as the first and second base stations 2 and 3 receive the position-inquiry signals S4, corresponding signals from the respective base stations 2 and 3 can be sent back to the wireless communication device 1. Upon such an arrangement, the travel time to either of the base station 2 or 3, as well as the distance (radius of the least-coverage circle), can still be determined.

By providing the positioning method capable of utilizing and handling signals from various wireless communication providers according to the present invention, the wireless communication device can then tell its location accurately anytime substantially without the limitations of the specific networks, constructions, geographical environments and so on.

While the present invention has been particularly shown and described with reference to a preferred embodiment, it will be understood by those skilled in the art that various changes in form and detail may be without departing from the spirit and scope of the present invention.

I claim:

1. A hybrid positioning method applied to a wireless communication device, the wireless communication device communicating with a first base station within a first network and a second base station within a second network, the hybrid positioning method comprising the steps of:
a. the wireless communication device receiving a first wireless signal from the first base station and a second wireless signal from the second base station;
b. computing time of transmitting the first wireless signal from the first base station to the wireless communication device and time of transmitting the second wireless signal from the second base station to the wireless communication device;
c. according to the computed time, determining a first domain which is capable of receiving the first wireless signal and a second domain which is capable of receiving the second wireless signal;
d. obtaining a coordinate of an intersection point of the first domain and the second domain; and
e. integrating the coordinate of the intersection point and a geographical data base to obtain a geographical position of the wireless communication device.

2. The hybrid positioning method according to claim 1, wherein the first network is a GSM (Global system for mobile communication) network and the second network is a CDMA (Code division multiple access) network.

3. The hybrid positioning method according to claim 1, wherein the geographical data base built in the wireless communication device is used for storing at least information of roads, streets, buildings, specific landmarks or particular geographic points.

4. The hybrid positioning method according to claim 1, wherein the first domain is a circle centered at the first base station and having a radius equal to a distance from the wireless communication device to the first base station, and the second domain is another circle centered at the second base station and having another radius equal to another distance from the wireless communication device to the second base station.

5. The hybrid positioning method according to claim 4, wherein in the step d, the first domain and the second domain have two intersection points (a first intersection point and a second intersection point), the hybrid positioning method further including the steps of:
d1. the wireless communication device receiving a third wireless signal from a third base station;
d2. computing time of transmitting the third wireless signal from the third base station to the wireless communication device;
d3. according to the computed time, determining a third domain which is capable of receiving the third wireless signal;
d4. when the third domain covers the first intersection point, obtaining a coordinate of the first intersection point, when the third domain covers the second intersection point, obtaining a coordinate of the second intersection point; and
d5. performing the step e.

6. The hybrid positioning method according to claim 5, wherein the third base station is within the first network.

7. The hybrid positioning method according to claim 5, wherein the third base station is within the second network.

8. A hybrid positioning method applied to a wireless communication device, the wireless communication device communicating with a first base station within a first network and a second base station within a second network, the hybrid positioning method comprising the steps of:
a. the wireless communication device transmitting signals to the first base station and the second base station respectively;
b. computing time of transmitting the signals from the wireless communication device to the first base station and the second base station respectively;
c. according to the computed time, determining a distance from the first base station to the wireless communication device and a distance from the second base station to the wireless communication device, and determining a first domain which is capable of receiving the first wireless signal and a second domain which is capable of receiving the second wireless signal;
d. obtaining a coordinate of an intersection point of the first domain and the second domain; and
e. integrating the coordinate of the intersection point and a geographical data base to obtain a geographical position of the wireless communication device.

9. The hybrid positioning method according to claim 8, wherein the first network is a GSM (Global system for mobile communication) network and the second network is a CDMA (Code division multiple access) network.

10. The hybrid positioning method according to claim 8, wherein the geographical data base built in the wireless communication device is used for storing at least information of roads, streets, buildings, specific landmarks orparticular geographic points.

11. The hybrid positioning method according to claim 8, wherein in the step d, the first domain and the second doamin have two intersection points (a first intersection point and a second intersection point), the hybrid positioning method further comprising the steps of:
d1. transmitting a third signal to a third base station;
d2. computing time of transmitting the third signal from the wireless communication device to the third base station;
d3. according to the computed time, determining a third domain which is capable of receiving the third signal;
d4. when the third domain covers the first intersection point, obtaining a coordinate of the first intersection point, when the third domain covers the second intersection point, obtaining a coordinate of the second intersection point; and
d5. performing the step e.

12. The hybrid positioning method according to claim 11, wherein the third base station is within the first network.

13. The hybrid positioning method according to claim 11, wherein the third base station is within the second network.

14. The hybrid positioning method according to claim 8, wherein the geographical data base is used for storing at least information of roads, streets, buildings, specific landmarks or particular geographic points.
